(19) United States
(12) Patent Application Publication
(10) Pub. No.: US 2022/0084108 A1
(43) Pub. Date: Mar. 17, 2022

(54) APPAREL VISUALIZATION SYSTEM AND METHOD THEREOF

(71) Applicant: ESHAKTI.COM PVT LTD, Chennai (IN)

(72) Inventors: Balan Gopala KRISHNAN, Chennai (IN); Arasu Shankher JEYAPRAKASH, Chennai (IN)

(21) Appl. No.: 17/310,103

(22) PCT Filed: Jan. 21, 2020
(86) PCT No.: PCT/IN2020/050062

§ 371 Date: Jul. 16, 2021

(30) Foreign Application Priority Data
Jan. 21, 2019 (IN) 201841048677

(51) Int. Cl. G06Q 30/06; G06T 7/11; G06T 11/00; G06F 3/0482

(52) U.S. Cl. CPC G06Q 30/0643; G06T 7/11; G06T 2200/24; G06F 3/0482; G06T 2207/20021; G06T 11/00

(57) ABSTRACT

The present invention is related to presentation of a representation of a garment or apparel to a viewer. The present invention particularly discloses a system [100] and method [200] for visualization of apparel, especially custom styling of the garment designed. It allows for real time drafting and preview of a garment with various style preferences selected by the customer. The method [200] for custom visualization of apparel in a computer based network, comprises accession [201] at a user interface [102] the apparel/garment display as a base/catalogue image [400] with default style options, selection [202] of custom style options by the user at the user interface [102], and processing of the base image [400] to depict/display the custom style option chosen by the user real time. The invention focuses on helping the customers in visualizing the garment or apparel that would be tailored to their style preferences.

### FIELD OF THE INVENTION

The present invention is related to presentation of a representation of a garment or apparel to a viewer. The present invention particularly discloses a system for visualization of apparel, especially custom styling of the garment designed. It allows for real time drafting and preview of a garment with various style preferences selected by the customer. The visualization system visually represents combinations of various style options by using a database comprising of smaller number of base images and thereby reducing the operational cost involved in delivering the feature to the end customer. The invention focuses on helping the customers in visualizing the garment or apparel that would be tailored to their style preferences and help them make a better purchase decision of a garment from an ecommerce site thus improving the customer experience and increase the loyalty to the brand as whole.

### BACKGROUND OF THE INVENTION

Computer automation has played an important role in the apparel industry. For example, it makes mass customization possible in a quick-turn environment.

Customers have started to purchase garments more and more from the online stores. In comparison to the large number of personalization options a customer is given in industries like automotive, digital devices etc. apparel industry is yet to improve. Customer rarely get to choose the type of styles involving the neckline shape, sleeve length or length of the dress and various other aspects of the garment. For a customer who is looking to buy a dress on an ecommerce platform it is hard for them to understand how the dress would fit on them. It becomes even harder to truly visualize the garment when they change the style different from the base design. This leads to a dissatisfied customer who receives a garment not in line with his/her expectations.

To address this issue and provide the customer with a comfortable shopping experience that lets them make the right decision, it is inevitable that they get to have a look of how the garment would be when tailored to their style preferences. In the current era of digital world this is made possible by the image processing tools available. But creating an image of how the garment would look like for each combination of style options and when done for each garment is time consuming and cause delay in bringing the garment on to the online store. More over having the entire garment image for each of the combination would increase the number and size of images to be maintained in the backend for each garment.

GB2536565A describes the system for displaying any wearables on customer by making digital image of the person and mapping the position of the wearable on the customer digital image. takes into account the customer preference data and the aesthetic compatibility of the individual variations to recommend a product to the customer while our patent only takes into account a fixed permissible style modifications for various individual parts of the base product that is made up by joining these individual parts and gives the customer to choose from this fixed set of style options for a selected base product. It doesn't give a real time visual representation of the product as the customer selects style modification.

U.S. Pat. No. 7,003,369B1 discloses a collaborative platform to facilitate approved designers and label owners to develop and deliver designs by working on one or more of the sewn product designs. It doesn't disclose a method for the customer to view the final product before placing the order, after they have made style modification on the base product based on their style preferences and the available style modification for the base product.

US20050289018A1 described system and method in the prior art talks about the process of customizing apparel like t-shirts, sweatshirts, crew neck shirts and camisoles with text or logos on the chosen apparel. It doesn't discuss about making style changes to a product and visually displaying, the modification on the base product, it to the customer in real time. It doesn't not talk about making any design changes to the garment itself but adding new elements to the garment like text and logo images

WO2003042778A2 the method to reorder a product that is custom fitted to a human being. It discloses method of modifying the article based in past selection of choice of the product. It doesn't provide a way to visually look at the modification done on a product before they place an order and not reorder from a previous order.

KR20150129597A primarily providing a system to the end customer by means of which they can select and communicate the information about the custom garment they want. A system by which they can communicate the details of the base design and customization information to be made on the base design. There is no limit or definition of the kind of customization of the garment. There is no reference to the generation techniques of the custom designed garment after receiving the design information from the customer via the system described in the patent.

There exists a need for a system and method for visualization of apparel, especially custom styling of the garment designed.

### OBJECTS OF THE INVENTION

It is the primary object of the present invention to provide a system for customized product visualization across various industries including apparel industry.

It is another object of the present invention to provide a system for real time visualization of selected product on a system.

It is another object of the present invention to provide a system and method for custom visualization of apparel by the customer before online purchase.

It is another object of the present invention wherein the system is enabled by a base image or catalogue image which is modified based on customer choice of style and size parameters and instantly represented visually.

It is another object of the present invention to provide a system with an ability to visually represent combinations of various style options by using a smaller number of base images and thereby reducing the operational cost involved in delivering the feature to the end customer.

It is another object of the present invention to provide a system and method wherein the system and method for visual representation of the selected product online is real time, and applied to any products where the customization of the design, or shape or any other customizable parameters are selected by the customer and represented on the modified image of the product.

It is another object of the present invention to provide a system and method wherein smart grid divides the catalogue or base image into different independent parts both manually or by machine learning and alters the image based on the style preferences applied on the garment.

It is another object of the present invention to provide a visualization system for a product for generating images for all variations of a certain style option and is performed for each type of style available style option.

It is another object of the present invention to provide a visualization system for a product wherein the optimizing of the process is done by creating minimum number of base images that would be used to generate the final set of all possible style option images.

It is the yet another object of the present invention to provide a system for customized product visualization across various industries including apparel industry.

### SUMMARY OF THE INVENTION

One or more of the problems of the conventional prior art may be overcome by various embodiments of the present invention.

It is the primary aspect of the present invention to provide a method for custom visualization of apparel in a computer based network, comprising:
accessing at a user interface the apparel/garment display as a base/catalogue image with default style options;
selection of custom style options by the user at the user interface;
the processing of the base image to depict/display the custom style option chosen by the user real time, comprising of steps:
   segmentation of the catalogue/base image into individual/independent units by a smart grid segmentation module for all possible variants of style;
   modification of different segments of the base image to correspond to individual style options by an image modification module and storing in a database;
   mapping of the segmented units with style type data provided in the database;
   choosing of the custom style option by the user at the interface;
   overlaying of the style options chosen by user on the corresponding segments of the base image, virtual stitching of the over laid segments with rest of the base image to generate a modified base image; and
   displaying of the modified base image for the user with custom style,
      wherein the base image comprises catalogue image of a model displaying a garment/apparel with default style options, and wherein the smart grid segmentation module is configured to segment the base image for all possible style options and a display module is configured to visually represent combination of all the chosen style options in a final modified base image.

It is another aspect of the present invention, wherein the base image is image of model displaying a base design with default style options for the apparel or garment.

It is another aspect of the present invention, wherein the smart grid is configured differently for different garments.

It is another aspect of the present invention, wherein segmentation of the catalogue/base image into individual/independent units is performed manually and segmented image is stored in the database of the system.

It is another aspect of the present invention to provide a system for custom visualization of apparel, comprising:
a computing module;
a processor;
user interface;
network;
a database storing base image of model displaying apparel with default style options and image segments representing all variants of custom style options;
one or more servers comprising:
   custom style module;
   smart grid segmentation module;
   image modification module;
   mapping module;
   image overlay module; and
   display module,
   wherein the user interface is in network communication with the server to choose the apparel of custom style preference, wherein the custom style module comprises of style options for neck, sleeve, length, others and the like, smart grid segmentation module divides the catalogue/base image into individual/independent units, image modification module retrieves segment of the base image corresponding to each style option and alters it for the custom style, mapping module maps the segmented individual unit of the base image with corresponding unit of custom style option and stores in the database, and wherein on accession of a custom style preference by the user, the image overlay module overlays the chosen style option on the corresponding segments of the base image, virtual stitches the over laid segments with rest of the base image to generate a modified base image and the display module provides the user visual representation of the model displaying apparel or garment with custom style preferences at the user interface.

It is another aspect of the present invention, wherein each segmented unit of the garment represents a type of style option chosen from neck, sleeve, length, other and the like.

It is another aspect of the present invention, wherein each style type is represented by one or more independent grids or blocks.

It is another aspect of the present invention, wherein the previously chosen user style options are stored in the database of the server for future reference.

It is another aspect of the present invention, wherein real time display of selected style preferences as an image comprises a combination of all chosen style preferences.

It is another aspect of the present invention, wherein the system is configured to display or provide a visual representation of all combinations of style preferences in the modified base image.

It is another aspect of the present invention, wherein the system is configured to alter or modify only that segment of base image on which the chosen style preference will overlay.

### BRIEF DESCRIPTION OF THE DRAWINGS

So that the manner in which the features, advantages and objects of the invention, as well as others which will become apparent, may be understood in more detail, more particular description of the invention briefly summarized above may be had by reference to the embodiment thereof which is illustrated in the appended drawings, which form a part of this specification. It is to be noted, however, that the drawings illustrate only a preferred embodiment of the invention and is therefore not to be considered limiting of the invention's scope as it may admit to other equally effective embodiments.

FIG. 1: illustrates the block diagram of the system for apparel visualization real time according to an embodiment of the present invention.

FIG. 2a illustrates an interface to specify the custom styling requirements of a customer according to an embodiment of the present invention.

FIG. 2b illustrates an Example 1 of the garment with the default style options according to an embodiment of the present invention.

FIG. 2c illustrates Example 2 according to an embodiment of the present invention.

FIG. 2d illustrates the list of garments with various styles tried out and saved by the customer according to an embodiment of the present invention.

FIG. 3a displays the interface used to upload the modification of the base image to generate the different variants of the style options according to another embodiment of the present invention.

FIG. 3b Displays the interface after the image store is created and style option variants are generated one after the other according to another embodiment of the present invention.

FIG. 4 Illustrates the Base image or catalogue image with segmentations exemplified by one particular style according to another embodiment of the present invention.

FIG. 5: Illustrates a flow chart of the method of visualization of the apparel real time according to another embodiment of the present invention.

### DESCRIPTION FOR DRAWINGS WITH REFERENCE NUMERALS

[100] System for apparel visualization real time
[101] Computing module
[102] User Interface
[103] Server
[104] Processor
[105] Database
[106] Custom style module
[107] Smart grid segmentation module
[108] Image modification module
[109] Mapping module
[110] Image overlay module
[111] Display module
[112] Network
[200] Method of visualization of the apparel real time
[201] Accessing at an interface the apparel/garment display as a base/catalogue image with default style options
[202] Selection of custom style options by the user at the interface
[203] Segmentation of the catalogue/base image into individual/independent units by smart grid segmentation module
[204] Modification of different segments of the base image to correspond to individual style options
[205] Storing in the database
[206] Mapping of the segmented units with style type data in database
[207] Choosing of the custom style option by the user at the interface
[208] Overlaying of the style options chosen by user on the corresponding segments of the base image
[209] Generation of a modified base image
[210] Displaying of the modified base image for the user with custom style
[300, 302, 303, 304] Exemplification of a particular apparel style
[400] Base image

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The present invention is related to presentation of a representation of a garment or apparel to a viewer. The present invention particularly discloses a system for visualization of apparel, especially custom styling of the garment designed. It allows for real time drafting and preview of a garment with various style preferences selected by the customer. The visualization system visually represents combinations of various style options by using a database comprising of smaller number of base images and thereby reducing the operational cost involved in delivering the feature to the end customer. The invention focuses on helping the customers in visualizing the garment or apparel that would be tailored to their style preferences and help them make a better purchase decision of a garment from an ecommerce site thus improving the customer experience and increase the loyalty to the brand as whole.

The invention builds on the ability of the customer to incorporate his/her styling preferences on a garment's or apparel's base design and helps them in visualizing how their preferences would modify the garment. This starts with understanding the list of all possible style options that can be provided on a garment. These are provided by the garment designer, once he/she completes get the garment design concept and the garment pattern. The industry uses the tech pack format to communicate the required details.

Using the garment details a base image [400] is developed with the default style options. Once the base image is available, it is used to generate the images that depict the styling options made available for that garment. The image goes through an image processing activity where different parts of the image are modified to develop the alternated look of that part corresponding to the selected style option. This processing can be achieved completely through machine, partially machine and man or complete manual intervention. Preferably it is a manual method wherein the base image is segmented or bifurcated based on specific coordinates to fit all possible style preferences to that image. Complete automation of this process can be done with the help of machine learning. In this method the machine detects the person and the garment on the person, type of garment. It identifies the various segments on the body, and the design of the garment on the segment. Combining this information with the style option selected the machine would modify the garment the garment on that segment of the body associated with the style option selected. In this process the machine should understand various aspects of the garment like fabric type, pattern on the fabric, repeating unit of the pattern, fall of the fabric on the human body and any other factor that determine the modification rules of the garment. It is possible that some of the information can be passed to the machine and other information must be learnt by the machine to modify any garment.

A partial automated system would involve part intervention of a human in directing the machine to modify the garment according to the styling preferences. Human intervention can guide the machine in understanding the area of modification on the body, where the garment needs to be modified per the desired style variant look. Similarly, intervention can also include assisting the machine in understanding other factors that influence the modification. Once the machine is configured to do the required changes, it generates the modified version of the base image that represents the desired variant of any style option. A complete intervention would involve the person understanding the garment type, fall of the fabric and some design sense to modify the garment per the desired variant of any style option.

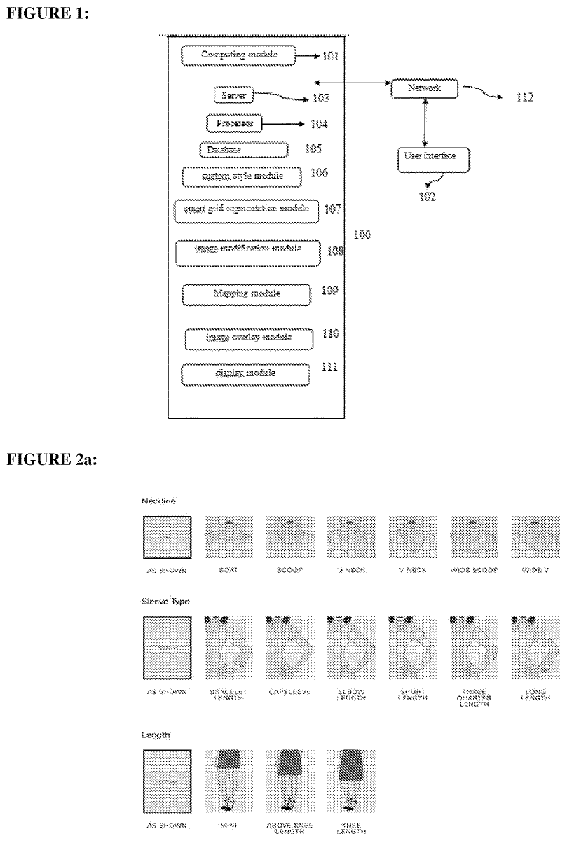

An embodiment of the present invention discloses a system, as illustrated in FIG. 1 for custom apparel visualization which comprises of a network enabled system which is accessible on any computer or internet enabled devices. The device wherein the ecommerce website is accessed could be chosen from one or more of computer, desktop, mobile, ipad, and the like.

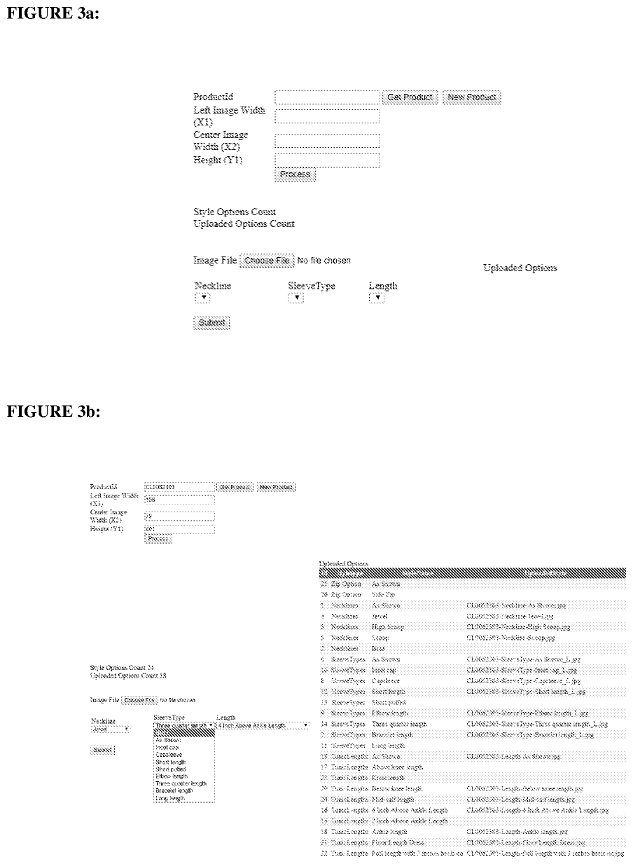

Referring to FIG. 1, block diagram of the system for apparel visualization real time is illustrated. The system [100] comprises of the components a computing module [101], user interface [102], a processor [104], network [112], a database [105] storing base image of model displaying apparel with default style options and image segments representing all variants of custom style options, one or more servers [103] comprising, custom style module [106], smart grid segmentation module [107], image modification module [108], mapping module [109], image overlay module [110] and display module [111], the user interface [102] is in network communication with server [103] to choose the apparel of custom style preference, wherein custom style module [106] comprises of style options for neck, sleeve, length, others and the like, smart grid segmentation module [107] divides the catalogue/base image into individual/independent units as illustrated in FIG. 4, for exemplification of a particular apparel style [300, 303, 302, 304], image modification module [108] retrieves segment of the base image corresponding to each style option and alters it for the custom style, mapping module [109] maps the segmented individual unit of the base image with corresponding unit of custom style option and stores in the database, wherein on accession of a custom style preference by the user, the image overlay module [110] overlays the chosen style option on the corresponding segments of the base image, virtual stitches the over laid segments with rest of the base image to generate a modified base image and the display module [111] provides the user visual representation of the model displaying apparel or garment with custom style preferences at the user interface.

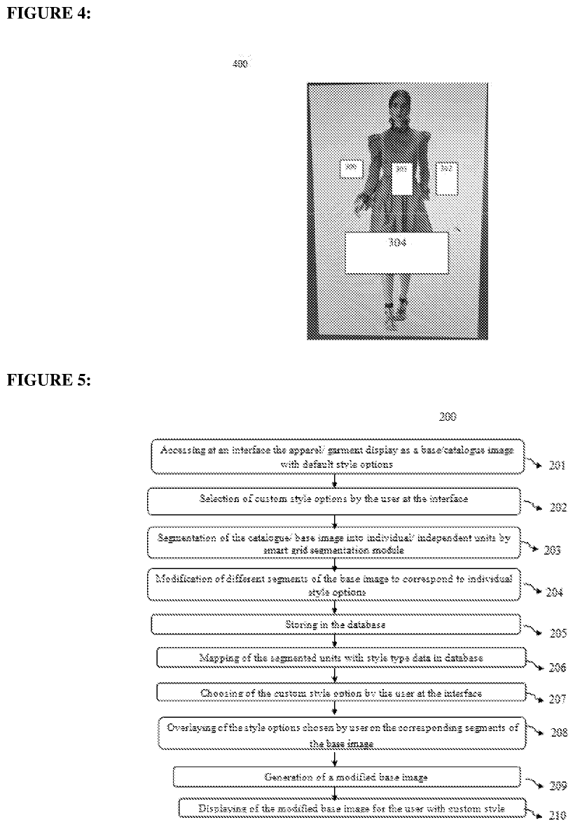

Referring to FIG. 5, a flow chart of the method [200] of visualization of the apparel real time is illustrated. A preferred embodiment of the present invention further discloses a method for custom visualization of apparel in a computer based network [112], comprising of steps of: accessing [201] at an user interface [102] the apparel/garment display as a base/catalogue image [400] with default style options, selection [202] of custom style options by the user at the interface [102], image processing of the base image [400] to depict/display the custom style option chosen by the user real time, wherein the system [100] as illustrated in FIG. 1 segmentation [203] of the catalogue/base image into individual/independent units by smart grid segmentation module [107] for all possible variants of style, modification [204] of different segments of the base image to correspond to individual style options by the image modification module [108] and storing [205] in the database [105]. Mapping [206] of the segmented units with style type data provided in the database, choosing [207] of the custom style option by the user at the interface, overlaying [208] of the style options chosen by user on the corresponding segments of the base image, virtual stitching of the over laid segments with rest of the base image to generate [209] a modified base image and displaying [210] of the modified base image for the user with custom style.

The base image [400] comprises catalogue image of a model displaying a garment/apparel with default style options. The smart grid segmentation module [107] is configured to segment the base image for all possible style options and the display module [111] is configured to visually represent combination of all the chosen style options in a final modified base image.

Image Processing Method: [FIG. 5]

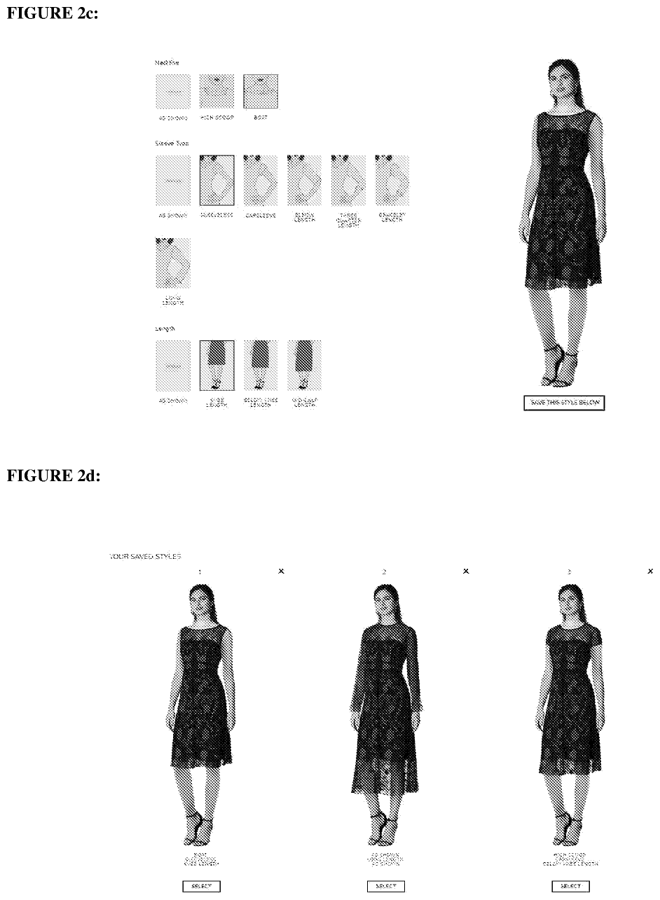

A catalogue image or base image [400] of the garment with the default style options, and following certain pose guidelines (for the model pose) is shot at the studio and the image is then broken down into segments based on the various style modifications possible and the areas of the garment these style modifications effect the image using the smart grid. As exemplified and illustrated in FIG. 4; The base image of the apparel or garment with default style options [400] is broken into 4 sections—the right hand [303], the left hand [302], the center body [303] and the bottom body [304]. Various garment types could have different types of smart grids. The smart grid configuration would be used by the final software to stitch the various segments of the images and produce the final modified image with the selected style options in real time. Now for each style option available for the garment, those sections of the image are taken and modified that get altered on selection of that style. The original image is not cut at the time of developing the style illustrates but rather by a software that will take input i) The digital illustrated image, ii) All style modifications the image contains, and the smart grid configurations as illustrated in FIG. 3a.

Using this input the system segments the image into units or segments and store them in the database [105]. The segments are mapped by mapping module [109] to the styles type data that they represent and stored in the database [105].

Ex: A original garment could have the default styles as

Neckline: PLUNGE V-NECK

Sleeve: SLEEVELESS

Length: MID-CALF LENGTH

Now a manually modified digital illustrate could have the following styles worked on the original image

Neckline: HIGH SCOOP

Sleeve: ELBOW LENGTH

Length: ANKLE LENGTH

This modified image is uploaded to the software, although the image segmentation is performed by segmentation module [107] the smart grid configuration is feed into the software along with the data of types of style modifications the image contains.

The software then breaks the image into smaller segments based on the grid configuration and saves each segment (say 4—referencing the image in point 2 above) mapping them with the corresponding style that segment represents (say segment 1,2 for ELBOW LENGTH right hand and left hand; segment 3 for the HIGH SCOOP neckline; segment 4 for ANKLE LENGTH length-style).

This process of cutting the image into segments and re using the segments to generate final required image by combining them reduces the total number of digital illustrates to be generated drastically a. Say if a garment has V1 variations of Style type S1, V2 variations of Style type S2, . . . , and Vn variations of Style type Sn. The re using technique brings the total number of digital illustrates to the generated from V1×V2×V3× . . . ×Vn to max of (V1, V2, . . . Vn).

Once all the images representing the possible style variation for a garments are generated and stored in the database the garment is put for sale with the interface for the customers to select styles of the garment and visually see the modified garment in real time.

In the interface when a style is selected, the corresponding segments that represent the style are fetched from the data store, overlaid on the corresponding segment where the modification is pertinent to, and this is enabled by the image overlay module [110], stitched together using the smart grid configuration of the garment and displayed by the display module [111] to the customer.

The total number of modifications of the base image [400] is the sum of all the style options and not the combination of various types of style options. Following this process, a special grid is designed and over-laid on that garment. The grid divides the entire garments into parts that represent a type of style option (like neckline, sleeve length, Dress length etc.). Taking one corner of the image as origin the coordinated of the grid lines is defined. It is designed in such a way that no two different types of style options fall in the same block of the grid.

A special software tool is developed for the following stages of the visualization engine. The objective of the tool is to cut the relevant style option variants from the modified versions of base image and store in the database for final usage. The tool is fed in the grid lines coordinates for a garment. It is possible to develop a completely automated system that is taught to understand garments and human body to automatically identify these coordinates on the base image. Based on the coordinates the uploaded image is cut and at most one variant of a style option type is stored. This process is repeated with a different modified image until all the available variants of the various style options are stored. The tool also provides a check list of the already store images for the garment making it convenient to upload the further necessary images to complete the entire set of images need by a garment.

The process of uploading the modified base images and generating & storing the style variant image is optimized in a way that ensures that minimum number of iterations of the upload, cut and store process is performed to generate the entire image set corresponding to the garment. The Ecommerce platform uses this set of images for a garment and drapes them together to generate the visual representation of the garment incorporated with the customer's style preferences. The image sets are tested for aesthetic look before they are made available to help the customer visualise his/her creation.

The need to change only a part of the image that is made by combining multiple images makes it possible to display any change is the style preferences without any lag. The entire structure of the process also gives the added advantage of storing lesser and smaller size images in place of entire images for each combination of different style types. Customers can select the style preferences provided for a garment through an interface that list the options to choose from. On selection of a variant of a style option, the garment visual will change to incorporate the new style variant. The customer is further provided with the ability to save each of their style types combinations and compare between their creations and select the one they feel would look best on them.

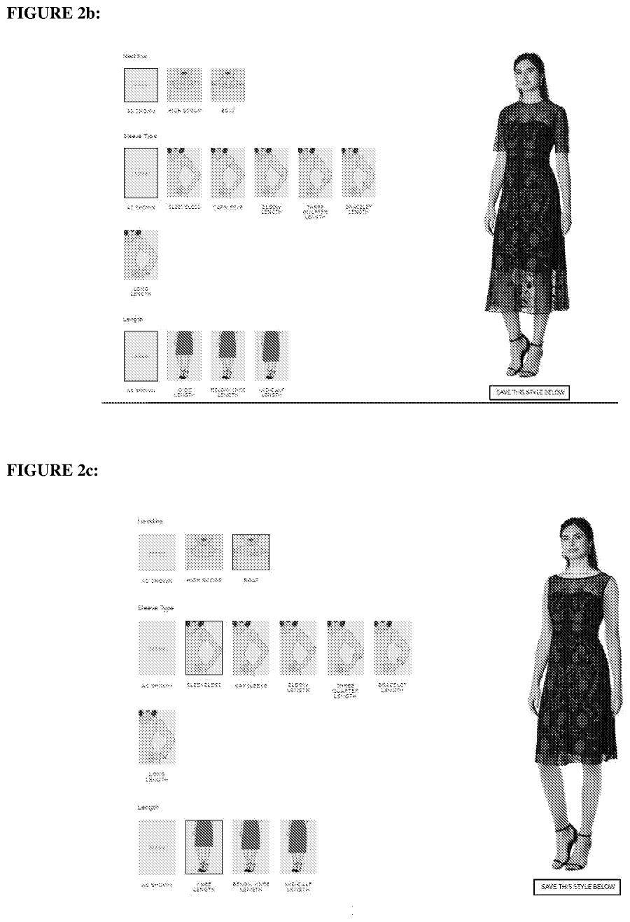

FIG. 2a illustrates an interface to specify the custom styling requirements of a customer according to an embodiment of the present invention.

### Example 1

As illustrated in FIG. 2b, is what customers see when they have not chosen to go for a different style from what is provided i.e it expresses default style options. The customer can get back to this visual after making any changes by selecting the “'As Shown variant” of each style type.

### Example 2

As illustrated in FIG. 2c, displays the style options of the garment with the customer's choice of style options. The customer has chosen “Boat” Neckline, “Sleeveless” Sleeve type and “Knee Length” Length customization. The garment visual changes as soon as the customer selects a new style option variant. This is implemented by the overlay module in the system which overlays that segment of the image with the altered neck image. The database has all the variants stored with respective mapping to the pertinent segment of the base image of FIG. 2b. Once the choice is made that “boat neck” part of the image is fetched from the database [105] and over laid on the respective segment in the modified image. The “Save this style Below” options save the images representing the selected style options. FIG. 2b illustrated the modified image of the customer choice real time after segmentation, and overlay as explained in detail in the detailed description above.

FIG. 2d: Illustrates that the customer can compare among their various creations and select among them. When they select one by pressing the “Select” button below the custom styled garment the corresponding style options in the custom styling interface are automatically changed. This lets them to directly add the custom styled garment into the cart without having to go back to the custom styling interface and change before adding to the cart.

FIG. 3a: Once the garment ID and the corresponding grid coordinates are given as input in the corresponding fields and processed, a store or database [105] is created for that garment to store its style variant images.

FIG. 3b: Illustrates the interface [102], where the “Style options count” gives the total possible number of style options available for the garment. Available style options data is created after the tech pack for the garment is provided. “Uploaded Options Count” gives the number of variants generated of the total available options. The modified base image is uploaded and the corresponding variant of style types the image contains is specified in the dropdowns available. In case a variant of some style options present in the modified image is already uploaded “NULL” option is selected from the corresponding dropdown. On submitting the modified image with the right selection of style options, style variant images are generated by cutting the modified image as per the grid coordinates.

Advantages of this System:

Generating digital illustrates of the garment with different styles (other than the default) saves the cost of manufacturing the garment with various style variations.

Re using of the segments and virtual stitching of the segments with the corresponding style components reduces the number of digital illustrates to be created.

This visualization system provides the customer visual representation of their custom styled garment in real time by maintaining a lot lesser number of images compared to the possible set of style options combinations. The use of the smart grid method, which is part of the engine, enables use of a smaller number of images to generate the visual representation of all possible combinations of style options available for a garment. Using smaller size images makes it possible for faster rendering of the visualization and better customer shopping experience.

In essence, this technology allows for the complete utilization of the style customization option provided to the customer and lets them pick the garment with the perfect style to their preferences in an operational efficient method for the garment store.

Although the invention has been described and illustrated with respect to the exemplary embodiments thereof, it should be understood by those skilled in the art that the foregoing and various other changes, omissions and additions may be made therein and thereto, without parting from the spirit and scope of the present invention.

We claim:

1. A method [200] for custom visualization of apparel in a computer based network, comprising:
accessing [201] at an user interface [102] the apparel/garment display as a base/catalogue image [400] with default style options;
selection [202] of custom style options by the user at the user interface [102];
characterized in that, the processing of the base image [400] to depict/display the custom style option chosen by the user real time, comprising of steps:
segmentation [203] of the catalogue/base image into individual/independent units by a smart grid segmentation module [107] for all possible variants of style;
modification [204] of different segments of the base image to correspond to individual style options by an image modification module [108] and storing [205] in a database [105];
mapping [206] of the segmented units with style type data provided in the database [105];
choosing [207] of the custom style option by the user at the interface [102];
overlaying [208] of the style options chosen by user on the corresponding segments of the base image, virtual stitching of the over laid segments with rest of the base image to generate [209] a modified base image; and
displaying [210] of the modified base image for the user with custom style,
wherein the base image [400] comprises catalogue image of a model displaying a garment/apparel with default style options, and
wherein the smart grid segmentation module [107] is configured to segment the base image for all possible style options and a display module [111] is configured to visually represent combination of all the chosen style options in a final modified base image.

2. The method [200] for custom visualization of apparel as claimed in claim 1, wherein the base image is image of model displaying a base design with default style options for the apparel or garment.

3. The method [200] for custom visualization of apparel as claimed in claim 1, wherein the smart grid is configured differently for different garments.

4. The method [200] for custom visualization of apparel in a computer based network as claimed in claim 1, wherein segmentation of the catalogue/base image into individual/independent units is performed manually and segmented image is stored in the database of the system.

5. A system [100] for custom visualization of apparel, comprising:
a computing module [101];
a processor [104];
user interface [102];
network [112];
a database [105] storing base image of model displaying apparel with default style options and image segments representing all variants of custom style options;
one or more servers [103] comprising:
custom style module [106];
smart grid segmentation module [107];
image modification module [108];
mapping module [109];
image overlay module [110]; and
display module [111],
wherein the user interface [102] is in network communication with the server [103] to choose the apparel of custom style preference,
wherein the custom style module [106] comprises of style options for neck, sleeve, length, others and the like, smart grid segmentation module [107] divides the catalogue/base image into individual/independent units, image modification module retrieves segment of the base image corresponding to each style option and alters it for the custom style, mapping module [109] maps the segmented individual unit of the base image with corresponding unit of custom style option and stores in the database [105], and
wherein on accession of a custom style preference by the user, the image overlay module [110] overlays the chosen style option on the corresponding segments of the base image, virtual stitches the over laid segments with rest of the base image to generate a modified base image and the display module [111] provides the user visual representation of the model displaying apparel or garment with custom style preferences at the user interface.

6. The system [100] for custom visualization of apparel as claim 5, wherein each segmented unit of the garment represents a type of style option chosen from neck, sleeve, length, other and the like.

7. The system [100] for custom visualization of apparel as claim 5, wherein each style type is represented by one or more independent grids or blocks.

8. The system [100] for custom visualization of apparel as claim 5, wherein the previously chosen user style options are stored in the database of the server for future reference.

9. The system [100] for custom visualization of apparel as claim 5, wherein real time display of selected style preferences as an image comprises a combination of all chosen style preferences.

10. The system [100] for custom visualization of apparel as claim 5, wherein the system is configured to display or provide a visual representation of all combinations of style preferences in the modified base image.

11. The system [100] for custom visualization of apparel as claim 5, wherein the system is configured to alter or modify only that segment of base image on which the chosen style preference will overlay.
